(19) United States
(12) Patent Application Publication
(10) Pub. No.: US 2024/0219879 A1
(43) Pub. Date: Jul. 4, 2024

(54) Method, System and Inspection Device for Securely Executing Control Applications

(71) Applicant: Siemens Aktiengesellschaft, Muenchen (DE)

(72) Inventors: Rainer FALK, Erding (DE); Christian Peter FEIST, München (DE); Axel PFAU, Freiburg (DE); Stefan PYKA, Markt Schwaben (DE); Daniel SCHNEIDER, München (DE); Franz SPERL, Oberviechtach (DE)

(21) Appl. No.: 18/562,882

(22) PCT Filed: May 4, 2022
(86) PCT No.: PCT/EP2022/061992

§ 371 Date: Nov. 21, 2023

(30) Foreign Application Priority Data
May 26, 2021 (EP) 21175999.8

(51) Int. Cl. G05B 19/042; G05B 23/02

(52) U.S. Cl. CPC G05B 19/0428; G05B 23/027

(57) ABSTRACT

A system, inspection device and method for securely executing control applications, wherein at least one event is defined for at least one control application and the event is triggered upon potential manipulation of program code associated with the control application and/or of at least one peripheral connected to a program flow controller processing the program code, where the program flow controller monitors a flow of the control application for deviations from an expected flow behavior and triggers the defined event upon a deviation, following triggering of the defined event, the program code is processed further by the program flow controller and the event is reported to an inspection device separate from the program flow controller where the inspection device places the control application and control components with an interdependency thereon into a predefined safe operating state upon detecting a flow behavior of the control application that contravenes the inspection rules.

### CROSS-REFERENCE TO RELATED APPLICATIONS

This is a U.S. national stage of application No. PCT/EP2022/061992 filed 4 May 2022. Priority is claimed on European Application No. 21175999 filed 26 May 2021, the content of which is incorporated herein by reference in its entirety.

### BACKGROUND OF THE INVENTION

### 1. Field of the Invention

The present invention relates to an inspection device, a method and system for the secure execution of control applications, in particular within an industrial automation system.

### 2. Description of the Related Art

Industrial automation systems usually comprise a large number of automation devices networked together via an industrial communication network and are used as part of a production or process automation system or other automation domain for controlling, regulating or monitoring of plants, machines or devices. Due to time-critical constraints in industrial automation systems, real-time communication protocols. such as PROFINET, PROFIBUS, Real-Time Ethernet or Time-Sensitive Networking (TSN), are predominantly used for communication between automation devices. In particular, control services or applications can be distributed automatically over currently available servers or virtual machines of an industrial automation system on a load-dependent basis.

WO 2014/109645 A1 relates to a method for monitoring an industrial control system, in which data is collected from one or more sources outside the industrial control system. Furthermore, data is collected from one or more internal sources of the industrial control system. In addition, the data collected from the internal sources or external sources is aggregated. The collected data is additionally analyzed by correlation with previously collected data to monitor a security status of the industrial control system.

WO 2020/182627 A1 describes a method for monitoring the integrity of an industrial cyber-physical system, in which measurement data collected with various sensors of the cyber-physical system, or control data intended for various actuators of the cyber-physical system, is provided or accessed. In addition, at least one measurement data context parameter is determined between the measurement data acquired with the various sensors, or at least one control data context parameter between the control data intended for the various actuators is determined. The at least one measurement data context parameter is compared with a measurement data context reference, or the at least one control data context parameter is compared with a control data context reference. Based on the comparison, the integrity of the cyber-physical system to be monitored is assessed.

WO 2020/212051 A1 discloses an industrial automation device, which comprises a monitoring unit for checking and monitoring the integrity status of the industrial automation device. In addition, at least one device component is provided, which communicates with the monitoring unit without feedback via a communication connection. The feedback-free communication comprises providing at least one device component parameter from the device component to the monitoring unit. The monitoring unit is designed to log and process the provided device component parameter of the device component of the industrial automation device for checking and monitoring the integrity status of the industrial automation device. Furthermore, the monitoring unit is designed to log and/or provide the integrity status of the industrial automation device as a result of the processed device component parameter of the device component of the industrial automation device. In addition, the monitoring unit is designed as a trusted device component that is protected against manipulation in the industrial automation device via a manipulation protection system.

WO 2021/164911 A1 discloses a computer-aided method for monitoring the integrity status of a computing device is known, in which an initialization value for an overall integrity value is first determined. The overall integrity value is then stored in a trusted memory area of a memory unit. An integrity status is then determined by an integrity detection system and an integrity status value is generated. The integrity status value is subsequently stored in the overall integrity value in the trusted memory area as the integrity status.

To prevent exploitation of existing vulnerabilities in program code, compiler-based exploit protection concepts can be used, for example, which insert additional protection or inspection routines into the program code during a compilation process. Such protection concepts can be purely software-based or implemented with hardware support. In particular, these protection concepts can be used to detect threats, such as code injection, buffer overflows, return-oriented programming (ROP) and jump-oriented programming (JOP) at run time. If a potential attack is detected, for example, then an error message is output on a command line or program execution is stopped immediately. This makes it difficult to exploit existing vulnerabilities. Typically, methods for detecting attacks and measures for responding to detected attacks are defined during the compilation process and can therefore no longer be changed at run time.

Despite the use of protective measures, malicious manipulation of program code for control applications provided by industrial automation devices cannot always be prevented. Often, patches aimed at addressing vulnerabilities in the program code are not available to the application sufficiently early or cannot be installed in a timely manner. In particular, running technical processes or operational restrictions in a system do not permit this at any arbitrary time. In addition, eliminating vulnerabilities by code patching can be a more or less complicated process, depending on the programming language used. Although many protection concepts allow a good balance between software performance and level of protection, false alarms (or false positives) can in principle occur, which signal an attack on program code even though there is no attack present. In industrial automation systems, it is extremely problematic when automation processes are stopped due to such false alarms. This usually leads to costly, unnecessary interruptions, quality-related problems, or even safety risks. Due to these problems, existing exploit protection concepts are often not applicable to industrial automation devices.

### SUMMARY OF THE INVENTION

It is an object of the present invention is to provide a method for the secure execution of control applications which, in particular when relying on exploit protection concepts, allows increased reliability via correctly detected threats and avoidance of processing interruptions caused by false alarms, and to provide a suitable implementation for carrying out the method.

These and other objects and advantages are achieved in accordance with the invention by a system, an inspection device, and a method for the secure execution of control applications, in which at least one event is defined for at least one control application, where the event in triggered in the event of a potential manipulation of program code assigned to the control application or of at least one peripheral device, which is connected to a program flow control device processing the program code. The program flow control device monitors the flow of the control application for deviations from an expected flow behavior and triggers the defined event in the event of a deviation. Here, the event may in particular include a designation of a code location within the program code, a time of occurrence of the defined event, an event type, or an error type.

In accordance with the invention, following triggering of the defined event, the program code continues to be processed by the program flow control device and the event is signaled to an inspection device separate from the program flow control device. When the event is signaled, the inspection device analyzes the flow behavior of the control application and the control components that are in a dependency relationship thereto using updatable inspection rules. The inspection rules are updated independently of the program flow of the control application. Preferably, the inspection device analyzes manipulations of the program code assigned to the control application and of the control components in a dependency relationship thereto in combination. Furthermore, the inspection device can advantageously analyze the flow behavior of the control application and the control components in a dependency relationship thereto depending on an operating state of the program flow control device and/or on at least one selected state.

Upon detection of a flow behavior of the control application contravening the inspection rules, in accordance with the invention the inspection device transfers the control application and the control components in a dependency relationship thereto into a predefined safe operating state. This offers the advantage that software, in particular running on industrial automation devices, can be reliably protected against attacks but does not need to be immediately stopped to do so. Instead, it possible to first ensure that an attack is not mistakenly identified as such. This allows controlled measures to be initiated in suspected cases in the event of potentially safety-critical error messages. This further enables a controlled technical system to be shut down in a controlled manner, to continue to be operated in a restricted operating mode (fail operational) in a controlled manner or to be placed in a safe operating state (fail safe) in a controlled manner. With an analysis of a possible attack outsourced to the inspection device, the inspection rules can be reliably learned or defined, in particular during a test phase. It is not necessary to modify the software itself. Overall, the analysis outsourced to the inspection device can correctly evaluate detected potential attacks with a significantly higher probability.

Preferably, the predefined safe operating state comprises stopping the control application, stopping the control components that are in a dependency relationship to the control application, activating a fault operating mode of an industrial automation device implemented via the control application, and/or signaling an alarm to an operator of an industrial automation system comprising the automation device. Alternatively or in addition, a reconfiguration of an output interface, in particular activation of a fail-safe mode, can be performed in the predefined safe operating state. Furthermore, the control application and the control components that are in a dependency relationship thereto can be stopped by a transfer into the predefined safe operating state within a specified time period after the event has been signaled.

The program code of the control application is preferably created via a first compile flag. The first compile flag activates at least one code sequence in the program code for performing inspections in the event of indirect function jumps, where the inspections is performed on each run of the control application. In particular, the inspections can be used during function calls to check a function prototype of a called function. Function prototypes include, in particular, the number and type of calling parameters and return values.

In accordance with a further preferred embodiment of the present invention, the program code of the control application is created by using a second compile flag. The second compile flag activates at least one code sequence in the program code, via which the program flow control device is caused to continue processing the program code of the control application pending further notice in the event of a deviation in the flow of the control application from the expected flow behavior. Error messages can still be output and processed.

Advantageously, events triggered by the program flow control device during operation of the control application in a secured environment are learned by the inspection device as false positives, which should be ignored by the inspection device when a corresponding event is signaled after completion of operation in the secured environment. Thus, the inspection rules can be created or updated in accordance with the learned false positives. Furthermore, events signaled to the inspection device in a learning phase can be selectively classified as critical or non-critical according to user interaction. Accordingly, the inspection rules can be reliably created or updated according to a classification of the events as critical or non-critical.

The system in accordance with the objects of the invention implements the method in accordance with disclosed embodiments and comprises at least one program flow control device and an inspection device separate from the program flow control device. The program flow control device is configured to process program code respectively assigned to control applications and to define at least one event for at least one control application, where the event is triggered upon a potential manipulation of program code assigned to the control application and/or of at least one peripheral device which is connected to a program flow control device processing the program code.

The program flow control device is additionally configured in accordance with the invention to monitor a flow of the control application for deviations from an expected flow behavior, to trigger the defined event in the event of a deviation, to continue to process the program code following triggering of the defined event, and to signal the event to the inspection device. By contrast, the inspection device is configured, upon signaling of the event, to analyze the flow behavior of the control application and control components in a dependency relationship thereto based on updatable inspection rules. In addition, the inspection device is configured to transfer the control application and the control components in a dependency relationship thereto into a predefined safe operating state upon detection of a flow behavior of the control application contravening the inspection rules.

The inspection device in accordance with the invention is intended for a system in accordance with the preceding embodiments and is configured, upon the signaling of a defined event that is triggered in the event of potential manipulation of program code assigned to a control application, to analyze a flow behavior of the control application and control components in a dependency relationship thereto using updatable inspection rules. In addition, the inspection device is configured to transfer the control application and the control components in a dependency relationship thereto into a predefined safe operating state upon detection of a flow behavior of the control application contravening the inspection rules.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is described in more detail below for an exemplary embodiment by reference to the drawing, in which:

FIG. 1 shows an industrial automation system having a plurality of program flow control devices, each providing at least one control application and having an inspection device for the analysis of potential manipulation attempts signaled by the program flow control devices;

FIG. 2 shows a schematic representation of message traffic between a plurality of program flow control devices and the inspection device in the event of potential manipulation attempts; and

FIG. 3 is a flowchart of the method in accordance with the invention.

### DETAILED DESCRIPTION OF THE EXEMPLARY EMBODIMENTS

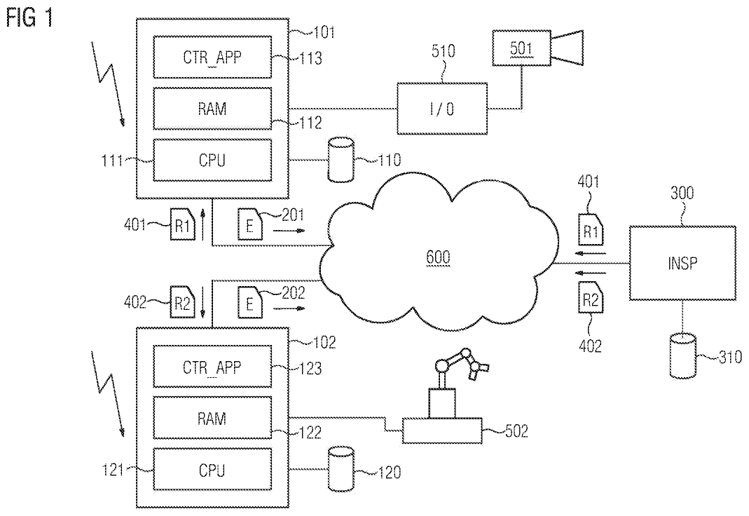

The industrial automation system shown in FIG. 1 comprises a plurality of program flow control devices 101-102 each implementing an automation device, and a separate inspection device 300 for the analysis of messages 201-202 of the program flow control devices 101-102 about potential manipulation attempts. The program flow control devices 101-102 and the inspection device 300 are connected to one another via an industrial communication network 600 which is preferably formed as a time-sensitive network, in particular in accordance with Institute of Electrical and Electronics Engineers (IEEE) standard 802.3—2018, IEEE standard 802.1Q—2018, IEEE standard 802.1AB—2016, IEEE standard 802.1AS—2011, IEEE standard 802.1BA—2011 and/or IEEE standard 802.1CB—2017. For example, forwarding of time-critical data within the communication network 600 can be controlled using frame preemption according to IEEE standard 802.1Q—2018, time-aware shaper according to IEEE standard 802.1Q—2018, credit-based shaper according to IEEE standard 802.1Q—2018, burst limiting shaper, peristaltic shaper or priority-based shaper.

Automation devices can be configured in particular as programmable logic controllers, control and monitoring stations, I/O controllers or I/O modules. Control and monitoring stations are used, for example, to display process data or measurement and control variables that are processed or acquired by programmable logic controllers, input/output units or sensors. In particular, control and monitoring stations can be used to display values of a control loop and to change control system parameters. Control and monitoring stations comprise at least one graphical user interface, an input device, a processor unit or processor, and a communication module.

In the present exemplary embodiment, the program flow control devices 101-102 each implement a programmable logic controller. Programmable logic controllers typically comprise a processor 111, 121 for processing program code for control applications 113, 123, a working memory 112, 122 for loading the program code, a communication module, and at least one input/output unit. Input/output units can in principle also be configured as distributed peripheral modules, which are arranged remote from a programmable logic controller. Via the communication module, a programmable logic controller can be connected to a network switch or router, or additionally to a fieldbus. The purpose of the input/output unit is to exchange control and measurement variables between the programmable logic controller 101, 102 and a machine or device 501, 502 controlled by the programmable logic controller 101, 102. The control applications are provided in particular for determining suitable control variables from recorded measurement variables.

In principle, separate I/O modules 510 can also be provided for the exchange of control and measurement variables with connected machines or devices 501, 502. I/O modules can be controlled in particular by means of one I/O controller per automation cell. Alternatively, I/O modules can also be controlled by an assigned programmable logic controller.

In the present exemplary embodiment, for the secure execution of the control applications 113, 123 provided by the program flow control devices 101, 102, at least one event is defined per control application 113, 123 and recorded in a configuration database 110, 120, where the event is triggered in the event of a potential manipulation of program code assigned to the respective control application 113, 123 or of a peripheral device that is connected to a program flow control device. In the present exemplary embodiment, such a peripheral device is the I/O module 510 connected to the program flow control device 101. However, it should be understood the application of the present invention is not limited to this type of peripheral device.

The program flow control devices 101, 102 each monitor a flow of their respective control application 113, 123 for deviations from an expected flow behavior and trigger the respective defined event in the event of a deviation. The respective defined event can in particular comprise a designation of a code location within the program code, a time of occurrence of the defined event, an event type, an error type and/or an error frequency. Depending on these information items and in particular on the basis of experience from previous signaled events, the inspection device 300 can decide whether an event is critical and requires further measures to mitigate risk, for example, stopping the respective control application 113, 123.

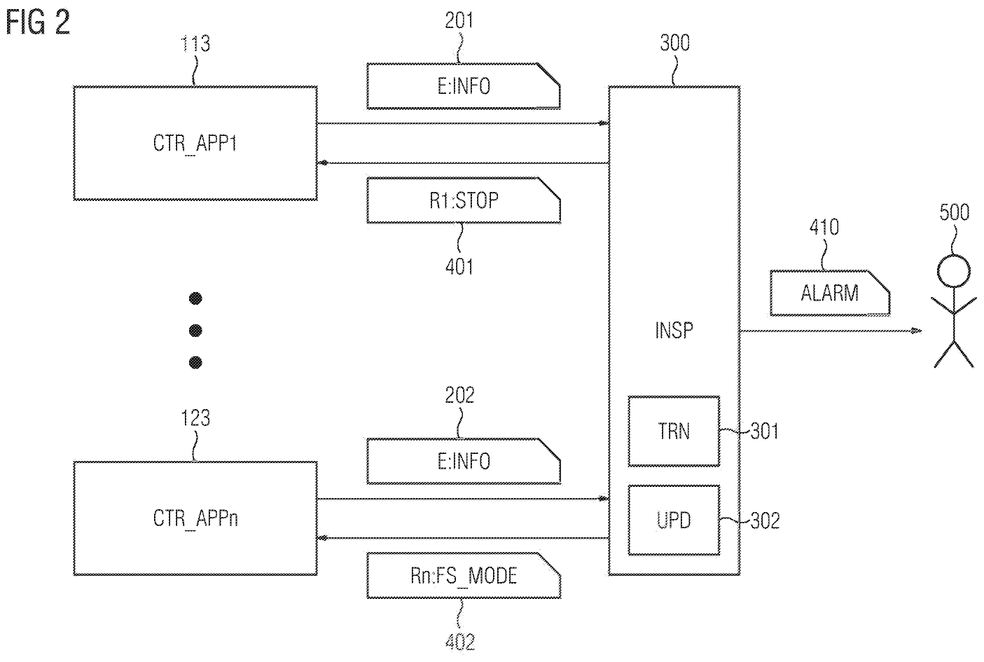

Following triggering of the respective defined event, the program code continues to be processed by the program flow control devices 101, 102 and the event is signaled to the inspection device 300. In each case, a message 201, 202 about a triggering of the respective defined event is transmitted to the inspection device 300 (see also FIG. 2).

Upon the signaling of the respective defined event, the inspection device 300 analyzes the flow behavior of the respective control application 113, 123 and control components in a dependency relationship thereto, for example, the I/O module 510, using updatable inspection rules that are stored in a rule database 310 of the inspection device 300. The inspection rules can be updated independently of the flow of the respective control application 113, 123. For this purpose, the inspection device 300 has an update module 302 (see FIG. 2).

Upon detection of a flow behavior of the respective control application contravening the inspection rules, the inspection device 300 transfers the control application 113, 123 and the control components in a dependency relationship thereto into a predefined safe operating state. For this purpose, the inspection device 300 transmits a corresponding message 401, 402 with a control sequence to the respective control application 113, 123 or program flow control device 101, 102. Advantageously, the inspection device 300 analyzes manipulations of the program code assigned to the respective control application 113, 123 and of the control components in a dependency relationship thereto in combination. In addition, the inspection device 300 analyzes the flow behavior of the respective control application 113, 123 and the control components in a dependency relationship thereto, preferably depending on an operating state of the respective program flow control device 101, 102 or on at least one selected state.

The predefined safe operating state can in particular comprise stopping the control application 113, 123, stopping the control components in a dependency relationship to the control application 113, 123, for example, the I/O module 510, activating a fault operating mode of an industrial automation device implemented via the control application, and/or signaling 410 an alarm to an operator 500 of the industrial automation system (see FIG. 2). Alternatively or in addition, the respective control application 113, 123 and the control components in the dependency relationship thereto can be stopped by a transfer to the predefined safe operating state within a specified time period after the event is signaled.

In accordance with a preferred embodiment, each program code for the control applications 113, 123 is created via a first compile flag. With such a first compile flag, for example “-fsanitize=cfi” in the Clang compiler, a code sequence is activated in the program code for performing inspections on indirect function jumps, where the inspections are performed at each run of the respective control application 113, 123. The inspections are used in particular during function calls to inspect a function prototype of a called function. In addition, the program code of the respective control application 113, 123 can be created via a second compile flag. With this second compile flag, for example “-fsanitize-recover=all” in the Clang compiler, a code sequence is activated in the program code, via which the program flow control device is caused to continue processing the program code of the respective control application 113, 123 pending further notice in the event of a deviation in the flow of the control application from the expected flow behavior.

As shown in FIG. 2, the inspection device 300 comprises a training or learning module 301 in addition to the update module 302. With this training or learning module 301, events triggered by the respective program flow control device 101, 102 during operation of the respective control application 113, 123 in a secured environment are learned by the inspection device as false positives, which should be ignored by the inspection device when a corresponding event is signaled after completion of the operation in the secured environment. The inspection rules are then created or updated according to the false positives that have been learned. Furthermore, events signaled to the inspection device 300 in a learning phase can be selectively classified as critical or non-critical according to user interaction. The inspection rules are then created or updated according to the classification of the events as critical or non-critical.

The inspection device 300 can be implemented in different forms, namely as an integrated, separate software component on a program flow control device, as a component on an external device which is connected via an I/O interface, or as an implementation on an external server, such as an edge or cloud computing server.

in principle, additional embodiments are possible in order to update the inspection rules for the inspection device 300.
For example, the learning phase can be supervised by a developer, who analyzes the errors in more detail and defines or updates the inspection rules accordingly.

The inspection device can apply methods based on artificial intelligence or machine learning to update the inspection rules. By analyzing common, identical error events of one or more binary files, and in particular depending on analyses of subsequent events, the inspection device performs additional learning and adapts its inspection rules accordingly. This allows for learning towards a correct analysis.
In analyses of the inspection device and in appropriately updated inspection rules, it is advantageously possible to take into account the environment in which the respective control application is provided.
Analyses can advantageously be performed depending on a location of an error occurrence. For example, no response occurs when an error occurs in a less critical code segment. For code segments with critical parts, such as functions for a network protocol stack, an error can be considered critical and an appropriate action can be taken.
A whitelist for the inspection device can also be used to define which errors are non-critical and can be ignored. Such whitelists are preferably also updated.
Training of the inspection rules for the inspection device on false positives can also be simulated and optimized in a digital twin, for example, before production goes live.

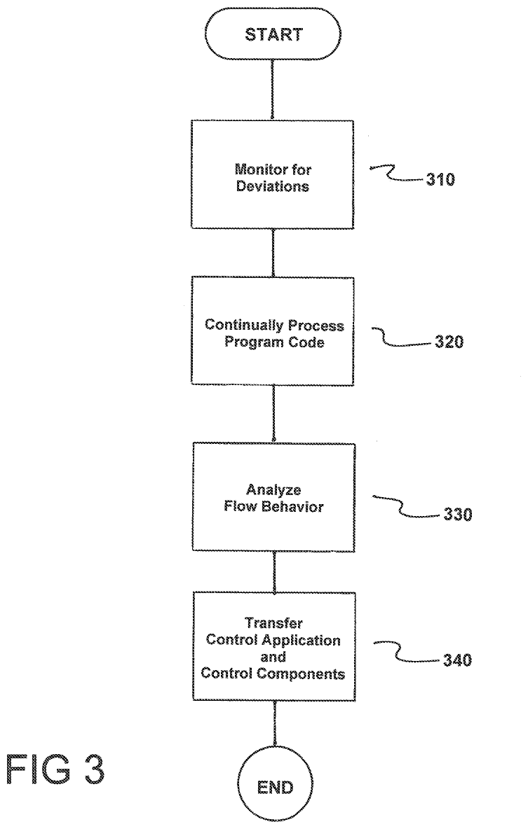

FIG. 3 is a flowchart of the method for securely executing control applications, where for at least one control application 113, 123, at least one event is defined that is triggered in the event of potential manipulation of program code assigned to either the control application and/or at least one peripheral device 510 that is connected to a program flow controller 101, 102 processing the program code. The method comprises monitoring, by the program flow control device, the flow of the control application for deviations from an expected flow behavior and triggering the defined at least one event upon occurrence of a deviation, as indicated in step 310.

Next, subsequent to triggering of the defined at least one event, the program code is continually processed by the program flow control device and the defined at least one event is signaled to an inspection device (300) separate from the program flow control device, as indicated in step 320.

Next, the inspection device analyzes the flow behavior of the control application and control components in a dependency relationship thereto using updatable inspection rules upon the signaling 201, 202 of the at least one event, as indicated in step 330. In accordance with the inventive method, the updatable inspection rules is updated independently of the flow of the control application.

Next, the inspection device, transfers the control application and the control components in a dependency relationship thereto to a predefined safe operating state 401, 402 upon detection of a flow behavior of the control application contravening the inspection rules, as indicated in step 340.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A method for securely executing control applications, in which for at least one control application, at least one event being defined which is triggered in an event of potential manipulation of program code assigned to at least one of the control application and at least one peripheral device which is connected to a program flow controller processing the program code, the method comprising:
monitoring, by the program flow control device, a flow of the control application for deviations from an expected flow behavior and triggering the defined at least one event upon occurrence of a deviation;
continually processing, subsequent to triggering of the defined at least one event, the program code by the program flow control device and signaling the defined at least one event to an inspection device separate from the program flow control device;
analyzing, by the inspection device, a flow behavior of the control application and control components in a dependency relationship thereto using updatable inspection rules upon the signaling of the at least one event, the updatable inspection rules being updated independently of the flow of the control application; and
transferring, by the inspection device, the control application and the control components in a dependency relationship thereto to a predefined safe operating state upon detection of a flow behavior of the control application contravening the inspection rules.

15. The method as claimed in claim 14, wherein the at least one event comprises at least one of a designation of a code location within the program code, a time of occurrence of the defined event, an event type and an error type.

16. The method as claimed in claim 14, wherein the predefined safe operating state comprises at least one of stopping the control application, stopping the control components in a dependency relationship to the control application, activating a fault operating mode of an industrial automation device implemented via the control application and signaling an alarm to an operator of an industrial automation system comprising the automation device.

17. The method as claimed in claim 15, wherein the predefined safe operating state comprises at least one of stopping the control application, stopping the control components in a dependency relationship to the control application, activating a fault operating mode of an industrial automation device implemented via the control application and signaling an alarm to an operator of an industrial automation system comprising the automation device.

18. The method as claimed in claim 14, wherein the control application and the control components in a dependency relationship thereto are stopped by a transfer into the predefined safe operating state within a specified time period after the at least one event has been signaled.

19. The method as claimed in claim 14, wherein the inspection device analyzes manipulations of the program code assigned to the control application and manipulations of the control components in a dependency relationship thereto in combination.

20. The method as claimed in claim 14, wherein the inspection device analyzes the flow behavior of the control application and the control components in a dependency relationship thereto depending on at least one of an operational state of the program flow control device and at least one selected state.

21. The method as claimed in claim 14, wherein the program code of the control application is created via a first compile flag; wherein the first compile flag activates at least one code sequence in the program code to implement inspections for indirect function jumps; and wherein the inspections are performed on each run of the control application.

22. The method as claimed in claim 21, wherein the inspections are utilized to inspect a function prototype of a called function during function calls.

23. The method as claimed in claim 14, wherein the program code of the control application is created via a second compile flag; and wherein the second compile flag activates at least one code sequence in the program code, via which the program flow control device is caused to continue processing the program code of the control application pending further notice in the event of the deviation in the flow of the control application from the expected flow behavior.

24. The method as claimed in claim 14, wherein events triggered by the program flow control device during operation of the control application in a secured environment are learned by the inspection device as false positives, which should be ignored by the inspection device when a corresponding event is signaled after completion of operation in the secured environment; and wherein the inspection rules are at least one of created and updated according to the learned false positives.

25. The method as claimed in claim 14, wherein events signaled to the inspection device in a learning phase are classified selectively as critical or non-critical according to user interaction; and wherein the inspection rules are at least one of created and updated according to a classification of the events as critical or non-critical.

26. A system comprising:
at least one program flow control device; and
an inspection device separate from the program flow control device;
wherein the program flow control device is configured to process program code respectively assigned to control applications and to define at least one event for at least one control application, said event being triggered upon a potential manipulation of at least one of program code assigned to the control application and at least one peripheral device which is connected to a program flow control device processing the program code;
wherein the program flow control device is further configured to monitor a flow of the control application for deviations from an expected flow behavior, trigger the defined at least one event upon occurrence of a deviation, continue to process the program code subsequent to triggering of the defined at least one event and to signal the defined at least one event to the inspection device;
wherein the inspection device is configured, when the event is signaled, to analyze the flow behavior of the control application and control components in a dependency relationship thereto utilizing updatable inspection rules which are updated independently of the flow of the control application; and
wherein the inspection device is further configured to transfer the control application and the control components in a dependency relationship thereto into a predefined safe operating state upon detection of a flow behavior of the control application contravening the inspection rules.

27. An inspection device comprising:
a processor; and
memory;
wherein the inspection device is configured, upon the signaling of a defined event which is triggered upon potential manipulation of program code assigned to a control application, to analyze a flow behavior of the control application and control components in a dependency relationship thereto utilizing updatable inspection rules which are updated independently of the flow of the control application;
wherein the inspection device is further configured to transfer the control application and the control components in a dependency relationship thereto into a predefined safe operating state upon detection of a flow behavior of the control application contravening the inspection rules.
